(19) United States
(12) Patent Application Publication
(10) Pub. No.: US 2025/0077966 A1
(43) Pub. Date: Mar. 6, 2025

(54) MACHINE LEARNING DEVICE USING ADAPTIVE FEATURE SELECTION AND METHOD OF OPERATING THE SAME

(71) Applicant: ELECTRONICS AND TELECOMMUNICATIONS RESEARCH INSTITUTE, Daejeon (KR)

(72) Inventors: Cheol Ho Kim, Daejeon (KR); Junghoon Lee, Daejeon (KR); Byounghwa Lee, Daejeon (KR)

(21) Appl. No.: 18/667,206

(22) Filed: May 17, 2024

(30) Foreign Application Priority Data
Sep. 1, 2023 (KR) 10-2023-0116366

(51) Int. Cl. G06N 20/00

(52) U.S. Cl. CPC G06N 20/00

(57) ABSTRACT

Disclosed is a machine learning device, which includes a probability table generating device that generates, based on a data set received from an outside, a probability table and a conditional probability table, a correlation extraction device that generates correlation information associated with the target feature and the plurality of input features based on the data set, a feature weight extraction device that generates a feature weight for each of the plurality of input features based on at least some of first information among the correlation information, the probability table, and the conditional probability table, a feature selection device that calculates a feature importance based on second information among the correlation information and the feature weight and selects at least some of the plurality of input features based on the feature importance, and a model generating device that generates a prediction model including at least some of the selected input features.

### CROSS-REFERENCE TO RELATED APPLICATIONS

This application claims priority under 35 U.S.C. § 119 to Korean Patent Application No. 10-2023-0116366 filed on Sep. 1, 2023, in the Korean Intellectual Property Office, the disclosure of which is incorporated by reference herein in its entirety.

### BACKGROUND

Embodiments of the present disclosure described herein relate to a machine learning device, and more particularly, relate to a machine learning device using an adaptive feature selection technique and a method of operating the same.

Incremental machine learning methods continuously update a learning model even without previous learning data, in a varying feature space environment with changing features that make up the data, in a data stream input in real time or in multiple data sets provided regularly or irregularly.

However, in a dynamic environment with the varying feature space, new features may continuously emerge as incremental machine learning progresses. As new features continuously emerge, the complexity of the learning model increases due to the accumulation of features. As the complexity of the learning model increases, the computational complexity required for inference of the learning model may increase.

In addition, when features overlap with each other due to the accumulation of features or features unnecessary for inference remain in the learning model, noise may occur during the inference process of the learning model and the prediction performance of the learning model may decrease. Accordingly, a device and a method for selecting features advantageous for inference and prediction in an incremental machine learning environment with the varying feature space may be required.

### SUMMARY

Embodiments of the present disclosure provide a machine learning device and a method of operating the same that use an adaptive feature selection technique to improve inference performance in a dynamic environment with a feature space dimension that continuously increases as incremental machine learning progresses.

According to an embodiment of the present disclosure, a machine learning device includes a probability table generating device that generates, based on a data set received from an outside, a probability table with respect to a target feature of the data set and a conditional probability table with respect to the target feature of a plurality of input features of the data set, a correlation extraction device that generates correlation information associated with the target feature and the plurality of input features based on the data set, a feature weight extraction device that generates a feature weight for each of the plurality of input features based on at least some of first information among the correlation information, the probability table, and the conditional probability table, a feature selection device that calculates a feature importance based on second information among the correlation information and the feature weight and selects at least some of the plurality of input features based on the feature importance, and a model generating device that generates a prediction model including at least some of the selected input features.

According to an embodiment, after the data set is received, when a new data set is received from the outside, the probability table generating device may update the probability table and the conditional probability table with respect to the target feature based on the new data set.

According to an embodiment, the first information may include a degree of relevance of each of the plurality of input features with respect to the target feature and a degree of redundancy between the plurality of input features.

According to an embodiment, after the data set is received, when a new data set is received from the outside, the correlation extraction device may update the degree of relevance and the degree of redundancy based on the plurality of input features included in the new data set.

According to an embodiment, the second information may include a correlation between the plurality of input features conditioned on the target feature.

According to an embodiment, after the data set is received, when a new data set is received from the outside, the correlation extraction device may update the correlation based on the plurality of input features included in the new data set.

According to an embodiment, the feature selection device may include a feature importance extraction device that extracts the feature importance based on the second information and the feature weight, a feature importance comparison device that compares the extracted feature importance with a first threshold, and a feature extraction device that extracts the at least some of the plurality of input features based on the comparison result.

According to an embodiment, the feature extraction device may extract input features having a feature importance equal to or greater than the first threshold.

According to an embodiment, the feature importance extraction device may count other input features for input feature pair combinations and an input feature having second information equal to or greater than a second threshold, and may transmit information with respect to a first input feature that does not have second information equal to or greater than the second threshold to the feature extraction device based on the count result.

According to an embodiment, the feature importance extraction device may calculate an average value of the second information with respect to the second input feature having the second information greater than the second threshold with the other input features based on the count result, and may extract the feature importance based on the feature weight, average value, and the count result with respect to the second input feature.

According to an embodiment, the feature weight extraction device may receive the prediction model from the model generating device, may receive the probability table and the conditional probability table with respect to the target feature of the at least some of the selected input features from the probability table generating device, may receive first information with respect to the at least some of the selected input features from the correlation extraction device, and may re-extract a feature weight for each of the selected at least some input features based on at least some of the probability table, the conditional probability table with respect to the target feature of the selected at least some input features, and the first information.

According to an embodiment, the model generating device may receive the feature weight re-extracted from the feature weight extraction device, may generate a completed prediction model based on the re-extracted feature weight, and may perform an inference on at least some of the data sets based on the completed prediction model.

According to an embodiment, the data set may include data for generating the prediction model and data for performing the inference.

According to an embodiment of the present disclosure, a method of operating a machine learning device includes generating, by the machine learning device, based on a data set received from an outside, a probability table with respect to a target feature of the data set and a conditional probability table with respect to the target feature of a plurality of input features of the data set, generating, by the machine learning device, correlation information associated with the target feature and the plurality of input features based on the data set, generating, by the machine learning device, a feature weight for each of the plurality of input features based on at least some of first information among the correlation information, the probability table, and the conditional probability table, calculating, by the machine learning device, a feature importance based on second information among the correlation information and the feature weight and selecting at least some of the plurality of input features based on the feature importance, and generating, by the machine learning device, a prediction model including at least some of the selected input features.

According to an embodiment, the first information may include a degree of relevance of each of the plurality of input features with respect to the target feature and a degree of redundancy between the plurality of input features, and the second information may include a correlation between the plurality of input features conditioned on the target feature.

According to an embodiment, the selecting of at least some of the plurality of input features may include extracting a feature importance based on the second information and the feature weight, comparing the extracted feature importance with a first threshold, and extracting the at least some of the plurality of input features based on the comparison result.

According to an embodiment, the extracting of the feature importance may include counting other input features for input feature pair combinations and an input feature having second information equal to or greater than a second threshold, and calculating an average value of the second information with respect to the second input feature having the second information greater than the second threshold with the other input features based on the count result, and extracting the feature importance based on the feature weight, the average value, and the count result with respect to the input feature.

According to an embodiment, the generating of the feature weight may include re-extracting a feature weight for each of the selected at least some input features based on at least some of the probability table, the conditional probability table with respect to the target feature of the selected at least some input features, and the first information.

According to an embodiment, the generating of the prediction model may further include generating a completed prediction model based on the re-extracted feature weight, and performing, by the machine learning device, an inference on at least some of the data sets based on the completed prediction model.

According to an embodiment, the data set may include data for generating the prediction model and data for performing the inference.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a machine learning device, according to an embodiment of the present disclosure.

FIG. 2 is a diagram illustrating a detailed configuration of a feature selection device included in a machine learning device of FIG. 1.

FIG. 3 is a diagram illustrating a detailed configuration of a feature importance extraction device included in a feature selection device of FIG. 2.

FIG. 4 is a diagram illustrating a detailed configuration of a feature weight extraction device included in a machine learning device of FIG. 1.

FIG. 5 is a flowchart illustrating a method of operating a machine learning device that generates a prediction model, according to an embodiment of the present disclosure.

FIG. 6 is a flowchart illustrating a method of operating a machine learning device that performs inference based on a completed prediction model, according to an embodiment of the present disclosure.

### DETAILED DESCRIPTION

Hereinafter, embodiments of the present disclosure may be described in detail and clearly to such an extent that an ordinary one in the art easily implements the present disclosure.

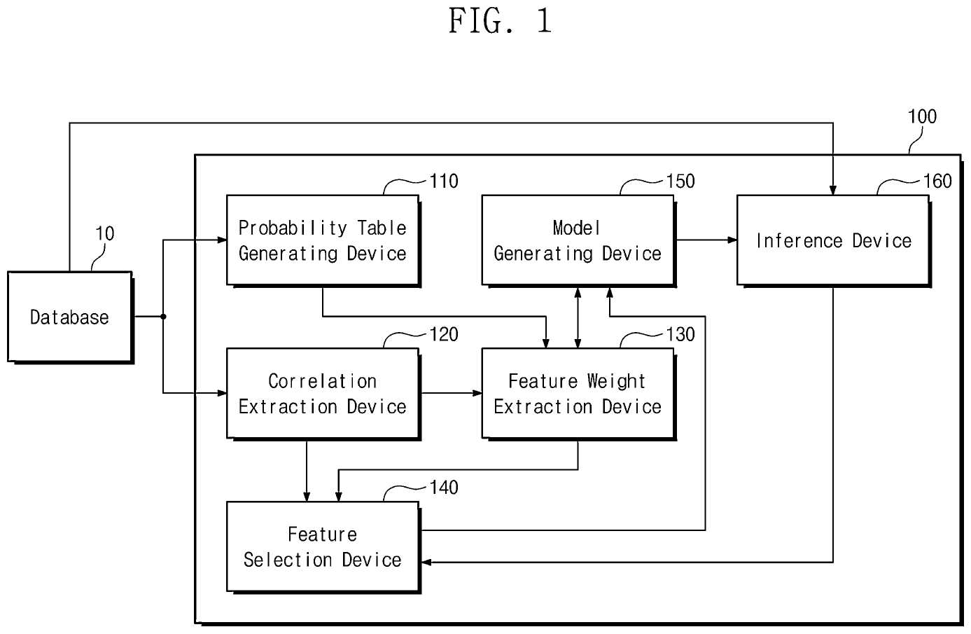

FIG. 1 is a diagram illustrating a machine learning device 100, according to an embodiment of the present disclosure. Referring to FIG. 1, the machine learning device 100 may include a probability table generating device 110, a correlation extraction device 120, a feature weight extraction device 130, a feature selection device 140, and a model generating device 150, and an inference device 160.

Each of the probability table generating device 110, the correlation extraction device 120, the feature weight extraction device 130, the feature selection device 140, the model generating device 150, and the inference device 160 may be implemented in the form of software or hardware, or a combination thereof.

For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

The machine learning device 100 may receive a data set from a database 10 located outside the machine learning device 100. The machine learning device 100 may generate a prediction model through incremental machine learning based on the received data set, and may perform inference and prediction on the data set using the prediction model.

In addition, the machine learning device 100 may gradually update the prediction model even without previous data sets when multiple data consisting of a plurality of data sets or each data set of data streams is sequentially input. In detail, the machine learning device 100 may generate a new prediction model each time a data set is input.

The data set may include data for generating a prediction model and data that are the subject of inference and prediction. The data for generating a prediction model may include a plurality of input features.

The machine learning device 100 may be implemented with at least one of a central processing unit (CPU), a graphics processing unit (GPU), an accelerated processing unit (APU), or a neural network processing unit (NPU), but the present disclosure is not limited thereto.

The machine learning device 100 may include a prediction model for performing the above-described incremental machine learning. For example, the prediction model may include a convolutional neural network (CNN), but the present disclosure is not limited thereto.

The probability table generating device 110 may designate a target feature with respect to a plurality of input features based on the received data set. The probability table generating device 110 may generate a probability table for the target feature and a conditional probability table for each of the input features with the target feature as a condition.

The conditional probability table for each of the input features with the target feature as the condition may refer to a conditional probability table with respect to the target feature of the input features.

The probability table generating device 110 may designate a node (a target node) (not illustrated) corresponding to the target feature and may form feature nodes (not illustrated) with respect to all input features. The probability table generating device 110 may connect each of the feature nodes (not illustrated) to the target node (not illustrated).

The probability table generating device 110 may generate an incremental classifier based on a probability table for the target feature and a conditional probability table for input features that are conditioned on the target feature.

The incremental classifier may be updated through learning based only on the current data set, even without the previous data set, in a situation where data sets come in sequentially. In detail, when a previous incremental classifier model is generated using a previous data set, the incremental classifier model may be updated based only on the current data set and the previous incremental classifier model, even without the previous data set.

The probability table generating device 110 may use a machine learning algorithm capable of sequential learning to generate the incremental classifier. As an example, the probability table generating device 110 may generate the incremental classifier (hereinafter referred to as a Naive Bayes-based incremental classifier) using a Naive Bayes-based classifier learning algorithm.

The Naive Bayes-based classifier learning algorithm may be an algorithm that assumes conditional independence between features.

The probability table generating device 110 may train the Naive Bayes-based incremental classifier by generating a probability table for the target feature and a conditional probability table for the target feature of each input feature based on data for generating a prediction model.

The probability table generating device 110 may configure a Bayesian network based on a conditional probability table for each input feature that is conditioned on the target feature or one or more input features.

When the probability table generating device 110 receives a new data set from the database 10, the probability table generating device 110 may update the Naive Bayes-based incremental classifier generated based on the existing data set. In detail, the probability table generating device 110 may update the probability table for the target feature and the conditional probability table for the target feature of each input feature based on the new data set.

For example, when a new data set has at least one new input feature that is not in the existing data set, the probability table generating device 110 may add a feature node corresponding to the new input feature to the existing Naive Bayes-based incremental classifier, and may connect the new feature node to the target node.

When a new data set has input features that are in the existing data set, the probability table generating device 110 may update the probability table and the conditional probability table based on the target feature and the input features.

The correlation extraction device 120 may extract the degree of relevance of between the target feature and each input feature and the degree of redundancy between input features based on the received data set. The correlation extraction device 120 may extract the degree of relevance and the degree of redundancy for the input features based on a joint probability between the target node (not illustrated) and each feature node (not illustrated), and between feature nodes (not illustrated).

The degree of relevance for the input features is obtained by quantifying a correlation between the target node (not illustrated) and a specific feature node (not illustrated) and normalizing it for all input features, and may indicate a relative relevance between the target node (not illustrated) and a corresponding feature node.

The degree of redundancy for input features is obtained by quantifying a correlation between a specific input feature and the remaining input features and normalizing it for all input features, and may indicate how much the distribution characteristics of the corresponding input feature overlap with other input features.

The correlation extraction device 120 may use at least one of a Pearson Correlation Coefficient, a Spearman Correlation Coefficient, and mutual information to quantify the correlation. However, the correlation extraction device 120 is not limited thereto and may quantify the correlation using various statistical calculation methods.

Hereinafter, in this specification, the correlation extraction device 120 will be described as quantifying the correlation using the mutual information.

The correlation extraction device 120 may further extract correlations between input features conditioned on the target node (not illustrated) in addition to the degree of relevance and the degree of redundancy with respect to the input features.

When quantifying the correlation using the mutual information, the correlation between input features conditioned on the target node (not illustrated) may be referred to as inter-feature mutual information.

The value of the inter-feature mutual information between an input feature X̅ᵢ̅ conditioned on a target feature (a target node) Y̅ and an input feature X̅ⱼ̅ may be greater than or equal to ‘0’ and less than or equal to ‘1’ (e.g., i̅,̅j̅ is an arbitrary integer, i̅≠̅j̅). The inter-feature mutual information I̅(̅X̅ᵢ̅,̅ X̅ⱼ̅|̅Y̅)̅ may be expressed in Equation 1 below.

$$\text{?} \qquad [ Equation 1 ]$$

$$\text{?} \text{indicates text missing or illegible when filed}$$

When the value that a target feature (a target node) Y may have is y, then y̅ may be \overline{y∈Val(Y)={1, 2, . . . , c}}. When the value of the input feature X̅ᵢ̅ is x̅ᵢ̅, and there are |̅X̅ᵢ̅|̅ numbers of values that x̅ᵢ̅ may have, then x̅ᵢ̅ may be \overline{xᵢ∈Val(Xᵢ)={x_{i,1}, x_{i,2}, . . . , x_{i,|X}_{ᵢ}_{|}}}. When the value of the input feature X̅ⱼ̅ is x̅ⱼ̅, and there are |Xⱼ| numbers of values that xⱼ may have, then xⱼ may be

$${x}_{j} ∈ Val ( {x}_{j} ) = \text{?}$$

$$\text{?} \text{indicates text missing or illegible when filed}$$

Thereafter, when the correlation extraction device 120 receives a new data set from the database 10, the correlation extraction device 120 may update the relevance, redundancy, and inter-feature mutual information extracted based on the existing data set.

For example, when the new data set has at least one new input feature that is not in the existing data set, the relevance, redundancy, and inter-feature mutual information between the new input feature and the existing input features may be added to the existing correlation information.

When the new data set has input features that are in the existing data set, the relevance, redundancy, and inter-feature mutual information with respect to the input features may be updated.

The feature weight extraction device 130 may receive information on the degree of relevance and redundancy of features from the correlation extraction device 120. The feature weight extracting device 130 may receive a probability table associated with the target feature and a conditional probability table for each of the input features conditioned on the target feature from the probability table generating device 110.

The feature weight extraction device 130 may extract a feature weight for each of the input features based on the degree of relevance and redundancy of the features, a probability table, and a conditional probability table. Alternatively, the feature weight extraction device 130 may extract the feature weight for each input feature based only on the degree of relevance and redundancy of the features.

When a new data set is input to the machine learning device 100, the feature weight extraction device 130 may receive information on updated relevance and redundancy from the correlation extraction device 120. In addition, the feature weight extraction device 130 may receive the updated probability table and conditional probability table from the probability table generating device 110.

The feature weight extraction device 130 may update the feature weight for each of the input features based on the updated relevance and redundancy, and the updated probability table and conditional probability table. Alternatively, the feature weight extraction device 130 may update the feature weight for each of the input features based only on the updated relevance and redundancy of the features.

For example, when the new data set includes at least one new input feature that is not in the existing data set, the feature weight extraction device 130 may extract the feature weight with respect to the new input feature.

When the new data set includes input features that are in the existing data set, the feature weight extraction device 130 may update the feature weight for each of the input features.

The feature selection device 140 may receive the inter-feature mutual information from the correlation extraction device 120. The feature selection device 140 may receive the feature weight for each of the input features from the feature weight extraction device 130.

The feature selection device 140 may calculate feature importance based on the feature weight and the inter-feature mutual information. The feature selection device 140 may include a feature importance calculation function. The feature selection device 140 may calculate feature importance based on the feature importance calculation function.

The feature selection device 140 may select at least some input features among a plurality of features included in the data set based on the feature importance.

When a new data set is input to the machine learning device 100, the feature selection device 140 may receive the added or updated inter-feature mutual information from the correlation extraction device 120. In addition, the feature selection device 140 may receive the added or updated feature weights from the feature weight extraction device 130.

The feature selection device 140 may update feature importance based on the updated feature weights and the updated inter-feature mutual information. The feature selection device 140 may update feature importance based on the feature importance calculation function.

For example, when the new data set includes at least one new input feature that is not in the existing data set, the feature selection device 130 may extract feature importance with respect to the new input feature.

When the new data set includes input features that are in the existing data set, the feature weight extraction device 130 may update the feature importance for each of the input features. A detailed description of the configuration of the feature selection device 140 will be described later.

The model generating device 150 may receive information on at least some input features from the feature selection device 140. The model generating device 150 may generate a prediction model including at least some input features. In this case, the remaining features that are not selected among the plurality of features included in the data set may not be included in the prediction model.

When a new data set is input to the machine learning device 100, the model generating device 150 may receive the updated feature importance from the feature selection device 140. The model generating device 150 may update the prediction model based on the updated feature importance.

For example, when the new data set includes at least one new input feature that is not in the existing data set, the model generating device 150 may generate a prediction model including the new input feature.

When the new data set includes the input features that are in the existing data set, the model generating device 150 may update the existing prediction model.

The feature weight extraction device 130 may receive a prediction model (or an updated prediction model) from the model generating device 150. The feature weight extraction device 130 may re-extract a feature weight for each of at least some input features included in the prediction model (or the updated prediction model) by utilizing a data set in an incremental machine learning process. A detailed description of this will be provided later in FIG. 4.

The model generating device 150 may receive the re-extracted feature weight from the feature weight extraction device 130. The model generating device 150 may regenerate the prediction model (or the updated prediction model) based on the re-extracted feature weight (hereinafter, the prediction model generated based on the re-extracted feature weight refers to a completed prediction model).

The inference device 160 may receive a completed prediction model (or an updated completed prediction model) from the model generating device 150. The inference device 160 may receive a data set from the database 10 external to the machine learning device 100. The inference device 160 may perform inference and prediction on the data set based on a completed prediction model (or an updated completed prediction model).

The feature selection device 140 may receive inference and prediction results from the inference device 160. The feature selection device 140 may adjust a feature selection method based on the inference and prediction results.

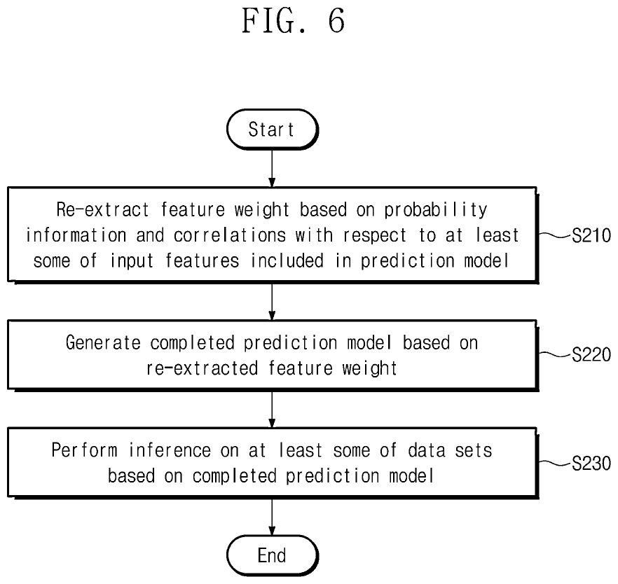

For example, the feature selection device 140 may optimize the feature importance calculation function based on the inference and prediction results. A detailed description of this will be provided later in FIGS. 4 and 6.

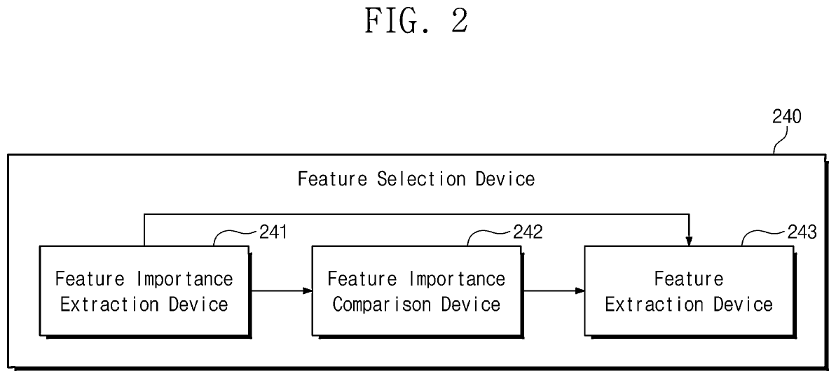

FIG. 2 is a diagram illustrating a detailed configuration of a feature selection device 240 included in a machine learning device of FIG. 1. By way of example, the feature selection device 240 of FIG. 2 may correspond to the feature selection device 140 included in the machine learning device 100 of FIG. 1. Accordingly, additional descriptions of similar configurations and operations are omitted to avoid redundancy.

Referring to FIGS. 1 and 2, the feature selection device 240 may include a feature importance extraction device 241, a feature importance comparison device 242, and a feature extraction device 243. Each of the feature importance extraction device 241, the feature importance comparison device 242, and the feature extraction device 243 may be implemented in the form of software, hardware, or a combination thereof.

The feature importance extraction device 241 may receive an inter-feature mutual information from the correlation extraction device 120. The feature importance extraction device 241 may receive the feature weight for each of the input features from the feature weight extraction device 130.

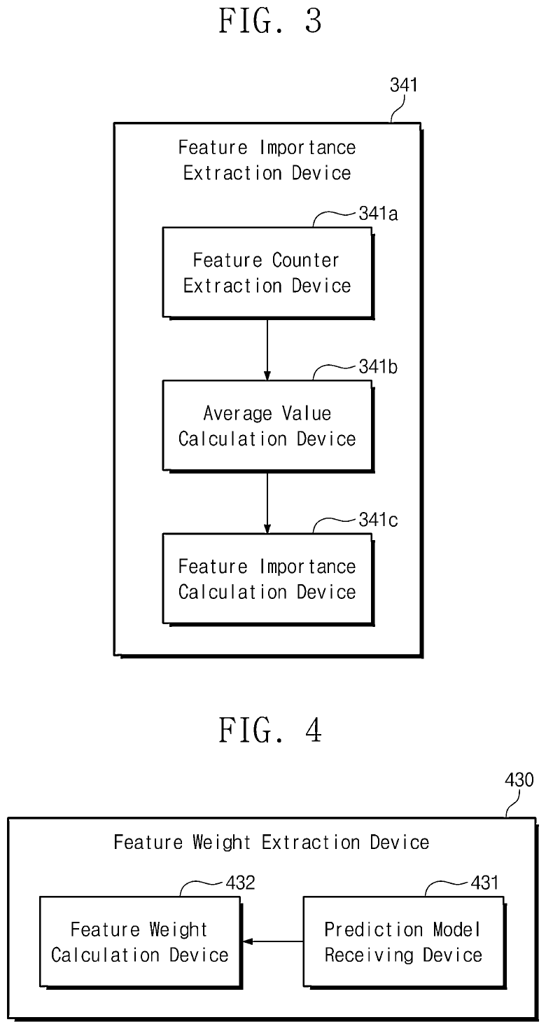

The feature importance extraction device 241 may extract the feature importance for each of the input features based on the inter-feature mutual information and the feature weight. The detailed configuration of this will be described later in FIG. 3.

The feature importance comparison device 242 may receive the feature importance for each of the input features from the feature importance extraction device 241. The feature importance comparison device 242 may compare the feature importance of each input feature with a threshold.

The feature extraction device 243 may receive a comparison result from the feature importance comparison device 242. The feature extraction device 243 may extract a set of input features of which feature importance is equal to or greater than the threshold.

Alternatively, the feature extraction device 243 may directly receive information on the input features from the feature importance extraction device 241. The detailed configuration of this will be described later in FIG. 3.

FIG. 3 is a diagram illustrating a detailed configuration of a feature importance extraction device included in a feature selection device of FIG. 2. By way of example, a feature importance extraction device 341 of FIG. 3 may correspond to the feature importance extraction device 241 included in the feature selection device 240 of FIG. 2. Accordingly, additional descriptions of similar configurations and operations are omitted to avoid redundancy.

Referring to FIGS. 1 to 3, the feature importance extraction device 341 may include a feature counter 341a, an average value calculation device 341b, and a feature importance calculation device 341c. Each of the feature counter 341a, the average value calculation device 341b, and the feature importance calculation device 341c may be implemented in the form of software, hardware, or a combination thereof.

The feature counter 341a may receive the inter-feature mutual information from the correlation extraction device 120. The feature counter 341a may count the number of input features having inter-feature mutual information equal to or greater than a threshold.

For example, the pairwise mutual information between two input features X̅ᵢ̅, X̅ⱼ̅ that are conditioned on the target feature Y̅ may be M̅ᵢ̅ⱼ̅ (i̅≠̅j̅,̅ 0̅≤̅M̅ᵢ̅ⱼ̅≤̅1̅). In this case, M̅ᵢ̅ⱼ̅=̅M̅ⱼ̅ᵢ̅ may be.

The set of input features that satisfy Mᵢⱼ≥θ (θ: threshold, 0≤θ≤1) and are included in the combination of h input feature pairs may be F̅_̅{̅θ̅}̅^̅{̅h̅}̅, and the number of feature pair combinations including the input feature X̅ᵢ̅ may be H̅_̅{̅θ̅}̅(̅X̅ᵢ̅)̅.

For example, it is assumed that F={X₁, X₂, X₃, X₄, X₅, X₆} and θ̅=̅0̅.̅6̅. In this case, among all ₙC₂ input feature pair combinations, when only M̅₂̅₃̅, M̅₂̅₄̅, M̅₂̅₆̅, M̅₃̅₄̅, M̅₅̅₆̅ is greater than 0.6, \overline{F_{θ}¹={X₆}}, \overline{F_{θ}²={X₃, X₄, X₅}}, \overline{F_{θ}³={X₂}} may be, H̅_̅{̅0̅.̅6̅}̅=̅(̅X̅₂̅)̅=̅3̅, H̅_̅{̅0̅.̅6̅}̅=̅(̅X̅₃̅)̅=̅H̅_̅{̅0̅.̅6̅}̅(̅X̅₄̅)̅=̅H̅_̅{̅0̅.̅6̅}̅=̅(̅X̅₅̅)̅=̅2̅, H̅_̅{̅0̅.̅6̅}̅=̅(̅X̅₆̅)̅=̅1̅. X̅₁̅ may not satisfy θ̅≥̅0̅.̅6̅ for any pair of input features. Therefore, \overline{F_{0.6}⁰={X₁}}, H̅_̅{̅0̅.̅6̅}̅(̅X̅₁̅)̅=̅0̅ may be.

Since the number of combinations of input feature pairs including input feature X̅₁̅ that satisfy the above conditions is ‘0’, the feature counter 341a may immediately transmit information on the input feature X̅₁̅ to the feature extraction device 243.

The average value calculation device 341b may receive mutual information between two features X̅ₖ̅ and X̅ₗ̅ satisfying M̅ₖ̅ₗ̅≥̅θ̅ (e.g., k and l are integers) from the feature counter 341a. The average value calculation device 341b may calculate the average value of the mutual information between the two features X̅ₖ̅ and X̅ₗ̅ based on the mutual information between the two features X̅ₖ̅ and X̅ₗ̅.

For example, when Mₐᵥₑ(Xᵢ) is the average value of Mₖₗ for the input feature pairs that the input feature X̅ᵢ̅ belongs to among the pairs of input features that satisfy M̅ₖ̅ₗ̅≥̅θ̅ (k̅≠̅l̅,̅ 0̅≤̅M̅ₖ̅ₗ̅≤̅1̅,̅ k̅,̅ l̅ is an integer), the average value M̅ₐ̅ᵥ̅ₑ̅(̅X̅ᵢ̅)̅ of the inter-feature mutual information including the input feature X̅ᵢ̅ may be expressed as Equation 2 below.

$${M}_{ave} ( {X}_{i} ) = \frac{1}{2 {H}_{θ} ( {X}_{i} )} {\sum }_{\begin{matrix}k , l \\ i ∈ \{ k , l \} \\ k \neq l \\ {M}_{kl} \geq θ\end{matrix}} {M}_{ki} \qquad [ Equation 2 ]$$

The feature importance calculation device 341c may receive the average value M̅ₐ̅ᵥ̅ₑ̅(̅X̅ᵢ̅)̅ of the inter-feature mutual information of pairs of input features to which the input feature X̅ᵢ̅ belongs from the average value calculation device 341b. The feature importance calculation device 341c may receive a feature weight w̅ᵢ̅ for each of the input features from the feature weight extraction device 130.

The feature importance calculation device 341c may include a feature importance calculation function f̅_̅{̅s̅c̅o̅r̅e̅}̅(̅X̅ᵢ̅)̅. The feature importance calculation device 341c may calculate the feature importance calculation function f̅_̅{̅s̅c̅o̅r̅e̅}̅(̅X̅ᵢ̅)̅ based on the feature weight w̅ᵢ̅, the number H̅_̅{̅θ̅}̅(̅X̅ᵢ̅)̅, of input feature pair combinations including the input feature X̅ᵢ̅, and the average value M̅ₐ̅ᵥ̅ₑ̅(̅X̅ᵢ̅)̅ of inter-feature mutual information including the input feature X̅ᵢ̅.

For example, the feature importance calculation function f̅_̅{̅s̅c̅o̅r̅e̅}̅(̅X̅ᵢ̅)̅ with respect to the input feature X̅ᵢ̅, may be expressed as the following equations (Equations 3 to 6).

$${f}_{score} ( {X}_{i} ) = {w}_{i} + {H}_{θ} ( {X}_{i} ) + {M}_{ave} ( {X}_{i} ) \qquad [ Equation 3 ]$$

In Equation 3, the value of the feature importance calculation function f̅_̅{̅s̅c̅o̅r̅e̅}̅(̅X̅ᵢ̅)̅ may be a simple sum of the feature weight w̅ᵢ̅, the number H̅_̅{̅θ̅}̅(̅X̅ᵢ̅)̅, of input feature pair combinations including the input feature X̅ᵢ̅, and the average value M̅ₐ̅ᵥ̅ₑ̅(̅X̅ᵢ̅)̅ of inter-feature mutual information including the input feature X̅ᵢ̅.

$${f}_{score} ( {X}_{i} ) = {λ}_{1} {w}_{i} + {λ}_{2} {H}_{θ} ( {X}_{i} ) + {λ}_{3} {M}_{ave} ( {X}_{i} ) \qquad [ Equation 4 ]$$

In Equation 4, the value of the feature importance calculation function f̅_̅{̅s̅c̅o̅r̅e̅}̅(̅X̅ᵢ̅)̅ may be a sum obtained by multiplying the feature weight w̅ᵢ̅, the number H̅_̅{̅θ̅}̅(̅X̅ᵢ̅)̅, of input feature pair combinations including the input feature X̅ᵢ̅, and the average value M̅ₐ̅ᵥ̅ₑ̅(̅X̅ᵢ̅)̅ of inter-feature mutual information including the input feature X̅ᵢ̅ by a coefficient λ̅₁̅,̅ λ̅₂̅,̅ λ̅₃̅, respectively.

Each coefficient λ̅₁̅,̅ λ̅₂̅,̅ λ̅₃̅ may be adjusted depending on the inference and prediction results of the inference device 160.

$${f}_{score} ( {X}_{i} ) = {w}_{i} \cdot {H}_{θ} ( {X}_{i} ) \cdot {M}_{ave} ( {X}_{i} ) \qquad [ Equation 5 ]$$

In Equation 5, the value of the feature importance calculation function f̅_̅{̅s̅c̅o̅r̅e̅}̅(̅X̅ᵢ̅)̅ may be a simple product of the feature weight w̅ᵢ̅, the number H̅_̅{̅θ̅}̅(̅X̅ᵢ̅)̅, of input feature pair combinations including the input feature X̅ᵢ̅, and the average value M̅ₐ̅ᵥ̅ₑ̅(̅X̅ᵢ̅)̅ of inter-feature mutual information including the input feature X̅ᵢ̅.

$${f}_{score} ( {X}_{i} ) = {w}_{i}^{{λ}_{2}} \cdot {{H}_{θ} ( {X}_{i} )}^{{λ}_{2}} \cdot {{M}_{ave} ( {X}_{i} )}^{{λ}_{2}} \qquad [ Equation 6 ]$$

In Equation 6, the value of the feature importance calculation function f̅_̅{̅s̅c̅o̅r̅e̅}̅(̅X̅ᵢ̅)̅ may be the product of the feature weight w̅ᵢ̅, the number H̅_̅{̅θ̅}̅(̅X̅ᵢ̅)̅, of input feature pair combinations including the input feature X̅ᵢ̅, and the average value M̅ₐ̅ᵥ̅ₑ̅(̅X̅ᵢ̅)̅ of inter-feature mutual information including the input feature X̅ᵢ̅, with indices λ̅₁̅,̅ λ̅₂̅,̅ λ̅₃̅, respectively.

Each index λ̅₁̅,̅ λ̅₂̅,̅ λ̅₃̅ may be adjusted depending on the inference and prediction results of the inference device 160.

However, the feature importance calculation function f̅_̅{̅s̅c̅o̅r̅e̅}̅(̅X̅ᵢ̅)̅ may be expressed in various equations in addition to Equation 3 to Equation 6.

FIG. 4 is a diagram illustrating a detailed configuration of a feature weight extraction device included in a machine learning device of FIG. 1. By way of example, a feature weight extraction device 430 of FIG. 4 may correspond to the feature weight extraction device 130 included in the machine learning device 100 of FIG. 1. Accordingly, additional descriptions of similar configurations and operations will be omitted to avoid redundancy.

Referring to FIGS. 1 to 4, the feature weight extraction device 430 may include a prediction model receiving device 431 and a feature weight calculation device 432. Each of the prediction model receiving device 431 and the feature weight calculating device 432 may be implemented in the form of software, hardware, or a combination thereof.

The prediction model receiving device 431 may receive a prediction model (or an updated prediction model) from the model generating device 150. The prediction model (or the updated prediction model) may include at least some input features selected by the feature selection device 140 or 240 among a plurality of features included in the data set.

The feature weight calculation device 432 may receive a prediction model (or an updated prediction model) from the prediction model receiving device 431. The feature weight calculation device 432 may re-extract a feature weight for each of at least some input features by using a data set (or a new data set) in an incremental machine learning process.

For example, the number of input features included in the data set (or the new data set) may be 100, and the number of at least some input features selected by the feature selection device 140 or 240 may be 30.

In this case, the feature weight calculation device 432 may receive information about the degree of relevance and redundancy with respect to 30 input features from the correlation extraction device 120. The feature weight calculation device 432 may receive a probability table for the target feature and a conditional probability table for each of 30 input features conditioned on the target feature from the probability table generating device 110.

The feature weight calculation device 432 may re-extract the feature weight for each of the 30 input features based on the probability table for the target feature, the degree of relevance and redundancy for the 30 input features, and the conditional probability table. Alternatively, the feature weight calculation device 432 may re-extract the feature weight for each of the 30 input features based only on the degree of relevance and redundancy of the 30 input features.

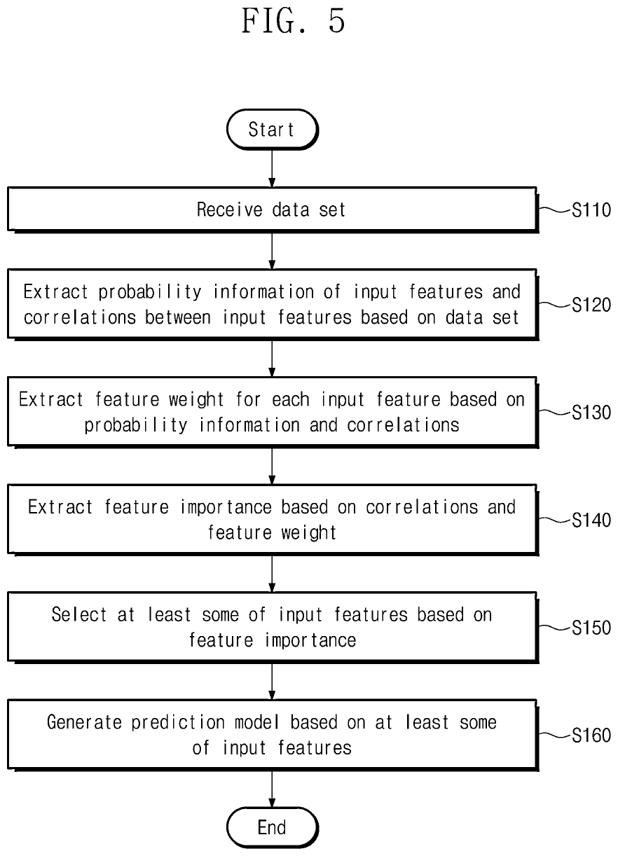

FIG. 5 is a flowchart illustrating a method of operating a machine learning device that generates a prediction model, according to an embodiment of the present disclosure.

Referring to FIGS. 1 to 5, in operation S110, the machine learning device 100 may receive a data set from a database external to the machine learning device 100. The data set may include a plurality of input features.

In operation S120, the machine learning device 100 may extract probability information of features and correlations between features based on the data set. The machine learning device 100 may designate a target feature with respect to input features.

The probability information may include a probability table for the target feature and a conditional probability table with respect to the target feature of each input feature that is conditioned on the target feature.

The correlation between features may include the degree of relevance of each input feature to the target feature, the degree of redundancy between each input feature, and the inter-feature mutual information that is conditioned on the target feature.

In operation S130, the machine learning device 100 may extract a feature weight for each feature based on the probability information and the correlations. In this case, the correlation may refer to the degree of relevance of each input feature to the target feature and the degree of redundancy between each input feature.

In operation S140, the machine learning device 100 may extract feature importance based on the correlations and the feature weight. In this case, the correlation may refer to the inter-feature mutual information that is conditioned on the target feature.

In operation S150, the machine learning device 100 may select at least some of the input features based on the feature importance. The machine learning device 100 may select an input feature that has a feature importance equal to or greater than the threshold among the input features. In addition, the machine learning device 100 may select an input feature of which the inter-feature mutual with respect to each of the other input features is less than a threshold.

In operation S160, the machine learning device 100 may generate a prediction model based on at least some of the selected input features. The generated prediction model may not be immediately transmitted to the inference device 160.

The feature weights for each of at least some input features included in the generated prediction model may be re-extracted. The machine learning device 100 may generate a completed prediction model based on the re-extracted feature weights. A detailed description of this will be provided later in FIG. 6.

FIG. 6 is a flowchart illustrating a method of operating a machine learning device that performs inference based on a completed prediction model, according to an embodiment of the present disclosure.

Referring to FIGS. 1 to 6, in operation S210, the machine learning device 100 may re-extract the feature weight based on probability information and correlations with respect to at least some of the input features included in the prediction model. In this case, the correlation may refer to the degree of relevance of at least some input features with respect to the target feature and the degree of redundancy between at least some input features.

In operation S220, the machine learning device 100 may generate a completed prediction model based on the re-extracted feature weight.

In operation S230, the machine learning device 100 may perform inference on at least some of the data sets based on the completed prediction model. At least some of the data sets may be data that are the subject of inference and prediction, unlike data for generating a prediction model.

The machine learning device 100 may adjust the coefficient or index of the feature importance calculation function by applying the inference results.

Thereafter, when a new data set is input, the machine learning device 100 may update the completed prediction model even without the previous data set.

As described above, the machine learning device 100 may extract probability information of input features and correlations between input features based on the new data set.

The machine learning device 100 may extract the feature weight for each of the input features based on probability information, the degree of relevance of each input feature with respect to the target feature, and the degree of redundancy between each input feature.

The machine learning device 100 may extract feature importance based on the feature weight and inter-feature mutual information between features that are conditioned on the target feature.

The machine learning device 100 may select at least some of the input features based on the feature importance.

The machine learning device 100 may generate a prediction model based on at least some selected input features.

The machine learning device 100 may re-extract feature weights based on probability information with respect to at least some of the input features included in the prediction model, the degree of relevance of at least some of the input features with respect to the target feature, and the degree of redundancy between at least some of the input features.

In detail, the machine learning device 100 may utilize information on at least some input features selected from among the input features included in the new data set.

The machine learning device 100 may generate a completed prediction model based on the re-extracted feature weights. In detail, the machine learning device 100 may update the completed prediction model corresponding to the previous data set to the completed prediction model corresponding to the new data set.

The machine learning device 100 may perform inference on at least some of the data sets based on the updated prediction model.

According to an embodiment of the present disclosure, the machine learning device and the method of operating the same may omit unnecessary features for inference and prediction by using an adaptive feature selection technique. Accordingly, the complexity of the learning model due to an increase in the feature space may be reduced, and the inference and prediction performance of the machine learning device may be improved.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A machine learning device comprising:
a probability table generating device configured to generate, based on a data set received from an outside, a probability table with respect to a target feature of the data set and a conditional probability table with respect to the target feature of a plurality of input features of the data set;
a correlation extraction device configured to generate correlation information associated with the target feature and the plurality of input features based on the data set;
a feature weight extraction device configured to generate a feature weight for each of the plurality of input features based on at least some of first information among the correlation information, the probability table, and the conditional probability table;
a feature selection device configured to calculate a feature importance based on second information among the correlation information and the feature weight, and to select at least some of the plurality of input features based on the feature importance; and
a model generating device configured to generate a prediction model including at least some of the selected input features.

2. The machine learning device of claim 1, wherein, after the data set is received, when a new data set is received from the outside, the probability table generating device is further configured to update the probability table and the conditional probability table with respect to the target feature based on the new data set.

3. The machine learning device of claim 1, wherein the first information includes a degree of relevance of each of the plurality of input features with respect to the target feature and a degree of redundancy between the plurality of input features.

4. The machine learning device of claim 3, wherein, after the data set is received, when a new data set is received from the outside, the correlation extraction device is further configured to update the degree of relevance and the degree of redundancy based on the plurality of input features included in the new data set.

5. The machine learning device of claim 1, wherein the second information includes a correlation between the plurality of input features conditioned on the target feature.

6. The machine learning device of claim 5, wherein, after the data set is received, when a new data set is received from the outside, the correlation extraction device is further configured to update the correlation based on the plurality of input features included in the new data set.

7. The machine learning device of claim 1, wherein the feature selection device includes:
a feature importance extraction device configured to extract the feature importance based on the second information and the feature weight;
a feature importance comparison device configured to compare the extracted feature importance with a first threshold; and
a feature extraction device configured to extract the at least some of the plurality of input features based on the comparison result.

8. The machine learning device of claim 7, wherein the feature extraction device is further configured to extract input features having a feature importance equal to or greater than the first threshold.

9. The machine learning device of claim 7, wherein the feature importance extraction device is further configured to:
count other input features for input feature pair combinations and an input feature having second information equal to or greater than a second threshold; and
transmit information with respect to a first input feature that does not have second information equal to or greater than the second threshold to the feature extraction device based on the count result.

10. The machine learning device of claim 9, wherein the feature importance extraction device is further configured to:
calculate an average value of the second information with respect to the second input feature having the second information greater than the second threshold with the other input features based on the count result; and
extract the feature importance based on the feature weight, average value, and the count result with respect to the second input feature.

11. The machine learning device of claim 1, wherein the feature weight extraction device is further configured to:
receive the prediction model from the model generating device;
receive the probability table and the conditional probability table with respect to the target feature of the at least some of the selected input features from the probability table generating device;
receive first information with respect to the at least some of the selected input features from the correlation extraction device; and
re-extract a feature weight for each of the selected at least some input features based on at least some of the probability table, the conditional probability table with respect to the target feature of the selected at least some input features, and the first information.

12. The machine learning device of claim 11, wherein the model generating device is further configured to:
receive the feature weight re-extracted from the feature weight extraction device,
generate a completed prediction model based on the re-extracted feature weight, and
perform an inference on at least some of the data sets based on the completed prediction model.

13. The machine learning device of claim 12, wherein the data set includes data for generating the prediction model and data for performing the inference.

14. A method of operating a machine learning device, the method comprising:
generating, by the machine learning device, based on a data set received from an outside, a probability table with respect to a target feature of the data set and a conditional probability table with respect to the target feature of a plurality of input features of the data set;
generating, by the machine learning device, correlation information associated with the target feature and the plurality of input features based on the data set;
generating, by the machine learning device, a feature weight for each of the plurality of input features based on at least some of first information among the correlation information, the probability table, and the conditional probability table;
calculating, by the machine learning device, a feature importance based on second information among the correlation information and the feature weight, and selecting at least some of the plurality of input features based on the feature importance; and
generating, by the machine learning device, a prediction model including at least some of the selected input features.

15. The method of claim 14, wherein the first information includes a degree of relevance of each of the plurality of input features with respect to the target feature and a degree of redundancy between the plurality of input features, and
the second information includes a correlation between the plurality of input features conditioned on the target feature.

16. The method of claim 14, wherein the selecting of at least some of the plurality of input features includes:
extracting a feature importance based on the second information and the feature weight;
comparing the extracted feature importance with a first threshold; and
extracting the at least some of the plurality of input features based on the comparison result.

17. The method of claim 16, wherein the extracting of the feature importance includes:
counting other input features for input feature pair combinations and an input feature having second information equal to or greater than a second threshold;
calculating an average value of the second information with respect to the second input feature having the second information greater than the second threshold with the other input features based on the count result; and
extracting the feature importance based on the feature weight, the average value, and the count result with respect to the input feature.

18. The method of claim 14, wherein the generating of the feature weight includes:
re-extracting a feature weight for each of the selected at least some input features based on at least some of the probability table, the conditional probability table with respect to the target feature of the selected at least some input features, and the first information.

19. The method of claim 18, wherein the generating of the prediction model further includes:
generating a completed prediction model based on the re-extracted feature weight, and
performing, by the machine learning device, an inference on at least some of the data sets based on the completed prediction model.

20. The method of claim 19, wherein the data set includes data for generating the prediction model and data for performing the inference.
